(19) United States
(12) Patent Application Publication
(10) Pub. No.: US 2005/0106436 A1
(43) Pub. Date: May 19, 2005

(54) Dual chamber fuel cell elements

(76) Inventor: Dennis Lazaroff, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/713,359

(22) Filed: Nov. 14, 2003

(51) Int. Cl. H01M 8/10; H01M 8/00; H01M 2/14; H01M 2/00; B05D 5/12; B23P 19/00

(52) U.S. Cl. 429/32; 429/38; 429/39; 29/730; 427/115

(57) ABSTRACT

Various embodiments of the invention comprise a dual chamber fuel cell element. The fuel cell element generally comprises a dual chamber fuel cell stack layer comprising anode, cathode and electrolyte materials deposited on one side of a substrate.

### BACKGROUND

1. Field of the Invention

The present invention generally relates to fuel cells.

2. Background Information

Fuel cell technology is of particular commercial interest. Ongoing research and development continues to further the scope of potential uses of this technology. Research traditionally focuses on areas with the potential for advancement. Considerations related to fuel cell efficiency, system efficiency, fuel cell element designs, overall size of the fuel cell and/or component parts, manufacturing costs and the like are all of great interest.

For example, dual chamber elements are designed to have the anode and cathode materials separated so that the reaction at each electrode is in a separate chamber. The separation of the anode and cathode materials may be done by depositing the materials on different sides of a relatively thick electrolyte material. The process for preparing these thick elements may be costly to manufacture. In addition, thicker electrolyte layers may be inefficient due to decreased ion flux. Thus, fuel cell technology using thinner electrolyte layers may increase fuel cell efficiency and be cost efficient. The subject matter described below addresses one or more of these issues.

### BRIEF SUMMARY

Various embodiments of the invention comprise a dual chamber fuel cell element. The fuel cell element generally comprises a dual chamber fuel cell stack layer comprising anode, cathode and electrolyte materials deposited on one side of a substrate.

### BRIEF DESCRIPTION OF THE DRAWINGS

For a detailed description of the embodiments of the invention, reference will now be made to the accompanying drawings in which:

FIG. 1 shows a fuel cell element in accordance with one embodiment of the invention;

FIG. 2 shows a fuel cell in accordance with one embodiment of the invention;

FIG. 3a shows a developing fuel cell element in accordance with one embodiment of the invention;

FIG. 3b shows the fuel cell element of FIG. 3a further developed in accordance with one embodiment of the invention; and

FIG. 3c shows the fuel cell element of FIG. 3b further developed in accordance with one embodiment of the invention.

### NOTATION AND NOMENCLATURE

Certain terms are used throughout the following description and claims to refer to particular system components. As one skilled in the art will appreciate, individuals and companies may refer to a component by different names. This document does not intend to distinguish between components that differ in name but not function. The terms used herein are intended to have their customary and ordinary meaning. The disclosure should not be interpreted as disclaiming any portion of a term's ordinary meaning. Rather, unless specifically stated otherwise, definitions or descriptions disclosed herein are intended to supplement, i.e., be in addition to, the scope of the ordinary and customary meaning of the term or phrase.

In addition, where words are used interchangeably, e.g., “support and substrate,” or “prepared and manufactured,” it is intended that these terms individually will have a broader meaning than their ordinary meaning that incorporates the full scope of each interchangeable term. Thus, nothing herein should be interpreted as disclaiming or disavowal of a term's scope unless specifically stated as otherwise.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments of the invention may include thin fuel cell stacks, integrated flow passageways between a fuel cell stack and support and/or dual chamber fuel cell elements supported on a single side of a substrate. Other embodiments may comprise fuel cells or fuel cell systems having one or more of the above mentioned embodiments. Still other embodiments may include methods for preparing and/or manufacturing one or more of the above mentioned embodiments.

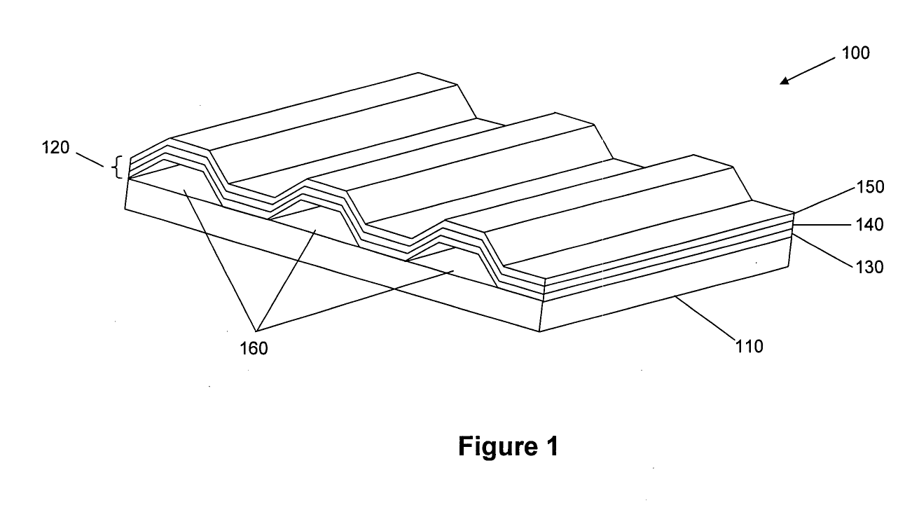

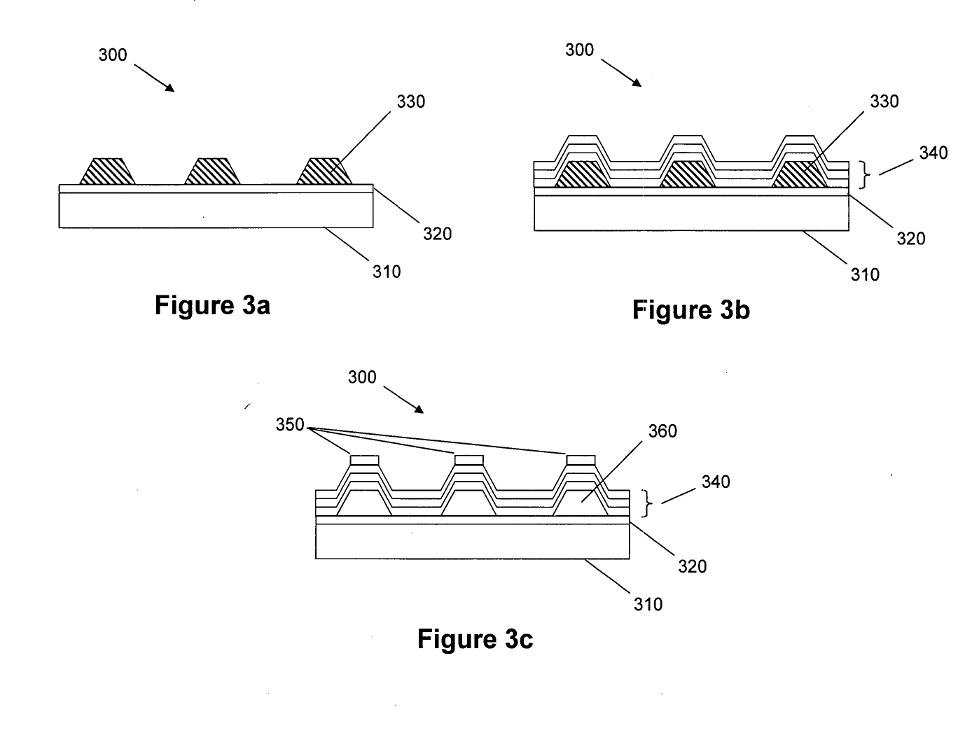

FIG. 1 shows a fuel cell element 100 in accordance with one embodiment of the invention. Fuel cell element 100 includes a stack 120 deposited on the support 110. The fuel cell stack 120 includes an anode layer 130, electrolyte layer 140 and cathode layer 150. It should be appreciated that the order of the layers may be reversed as desired and/or necessitated by a particular embodiment or use. For example, the stack may be deposited on the support as cathode, electrolyte then anode. As used herein, the phrase “deposited on” (or variations thereof) should not be interpreted to mean deposited directly on, but instead is intended to be open ended and include the possibility of other interfacial layers or components. For example, fuel cell 100 may also include current collectors (shown in FIGS. 3a-3d) that may be deposited between the stack the and support.

It will be appreciated that the particular electrode and electrolyte materials used in the embodiments of the invention are not critical to the spirit of the invention. The electrolyte material may be formed from any suitable material, as desired and/or necessitated by a particular end use. Suitable electrolyte materials may include, but are not limited to, cubic fluorite structure electrolytes, doped cubic fluorite electrolytes, proton-exchange polymer electrolytes, proton-exchange ceramic electrolytes, and mixtures thereof. Further, the electrolyte material may be yttria-stabilized zirconia (YSZ), samarium doped-ceria (SDC, CeₓSm_{y}O_{2δ}), gadolinium doped-ceria (GDC, CeₓGd_{y}O_{2-δ}), LaₐSr_{b}Ga_{c}Mg_{d}O_{3-δ} and mixtures thereof.

Likewise, the electrode material may be formed from any suitable material, as desired and/or necessitated by a particular end use. In general, the electrode materials may be comprised of metal(s), ceramic(s) and/or cermet(s). Examples of suitable anode materials include, but are not limited to, nickel, platinum, Ni-YSZ, Cu-YSZ, Ni-SDC, Ni-GDC, Cu-SDC, Cu-GDC and mixtures thereof. Examples of suitable cathode materials include, but are not limited to, silver, platinum and mixtures thereof; and samarium strontium cobalt oxide (SSCO, SmₓSr_{y}CoO_{3-δ}), barium lanthanum cobalt oxide (BLCO, BaₓLa_{y}CoO_{3-δ}), gadolinium strontium cobalt oxide (GSCO, GdₓSr_{y}CoO_{3-δ}) and mixtures thereof.

Stack 120 is shown with a peak and valley configuration. This type of configuration allows for the formation of one or more integrated flow passageways 160 between stack 120 and support 110. The shape of the flow passageways 160 are not critical to the invention and should not be limited to the shape as depicted in FIG. 1. This configuration may be used to flow one gas over one side of the stack 120 via flow passageways 160 and a second gas over the opposite side of the stack 120. For example, an oxygen containing gas may flow over the cathode layer 150 and a fuel gas stream may flow over the anode 130 via flow passageways 160. Thus, the first and second gas streams may remain separated when in contact with stack 120.

This type of configuration allows various embodiments of the invention to form dual chamber fuel cell stacks comprising anode, cathode and electrolyte materials deposited on one side of a substrate. It should be appreciated that the various embodiments are not limited to having stacks on only one side of the substrate, but may also include additional features on a second side of the substrate as desired or necessitated by a particular end use.

Irrespective of or in addition to the features described above, stack 120 may be very thin. The flux of oxygen ions through the electrolyte material 140 may be significantly increased, which may result in an increase in fuel cell efficiency by reducing the thickness of the electrolyte layer 140 between the anode 130 and cathode materials 150. In one embodiment, the individual layers of anode, electrolyte and cathode may be of equal thickness. In another embodiment, the electrolyte layer may be as thin as possible to increase the flux in the system.

Accordingly, one embodiment of the invention comprises a fuel cell element having a stack with a thickness of equal to or less than about 50 μm. Other embodiments of the invention comprise a fuel cell element having a stack with a thickness of equal to or less than about 20 μm. Still other embodiments of the invention comprise a fuel cell element having a stack with a thickness of equal to or less than about 1 μm. As used herein, the term “about” or “approximately,” when preceding a numerical value, has its usual meaning and also includes the range of normal measurement variations that are customary with laboratory instruments or techniques commonly used in this field of endeavor. In addition, it is within the scope of the various embodiments of the invention that the thickness of any one stack may not be constant. Thus, the thickness values described herein may represent any one single thickness measurement of the stack.

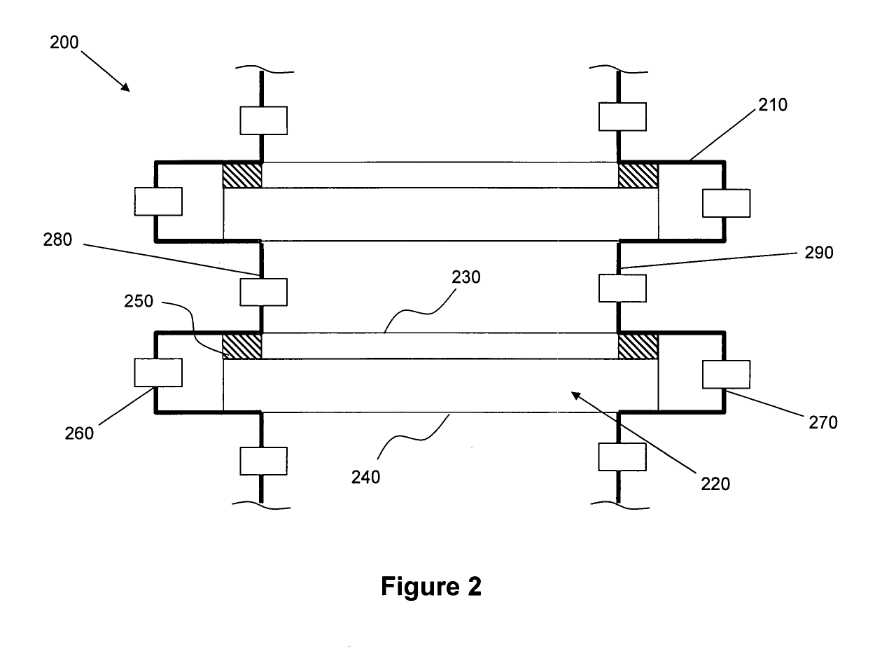

The various embodiments may be used to increase flux of a fuel cell element, which may result in an increase in fuel cell efficiency. Accordingly, various embodiments of the invention comprise fuel cell systems having one or more of the embodiments disclosed herein. FIG. 2 shows a fuel cell 200 having fuel cell element 210 and a fuel cell housing 220. It should be appreciated that additional fuel cell elements, which may or may not be similar to elements 210, may also be included in a final fuel cell assembly. In addition, the configuration of the fuel cell 200 is not critical to the various embodiments of the invention.

As shown, the fuel cell element 210 comprises a fuel cell stack 230 deposited on a support 240. Fuel cell stack 230 comprises anode, electrolyte and cathode layers (not shown). Fuel cell element 210 may have integrated flow passageways (not shown) between the fuel cell stack 230 and the support 240 as described in accordance with FIG. 1. Fuel cell element 210 is secured within the housing 220 of fuel cell 200. A sealing mechanism 250 may be located near the ends of fuel cell element 210 on the side having the deposited stack 230. The sealing mechanism 250 should be capable of making a gas tight seal along the edges of the stack 230, i.e., the seal should be capable of conforming to the shape of the deposited stack. For example, if fuel cell element 210 were to have a peak and valley configuration (as shown in FIG. 1), the sealing mechanism 250 should be capable of filling the valleys and well as covering the peaks.

The sealing mechanism used is not critical to the invention and may be any suitable sealing mechanism known or used in the art For example, suitable sealing mechanisms may include, but are not limited to, adhesives, gaskets, gels, cements and the like. Certain materials may be useful as a sealing mechanism after baking, e.g., a lubricant used for inserting the element may be baked forming a stable gas tight seal.

The sealing mechanism 250 should form a gas tight seal. Thus, a first gas may be passed through inlet 260, which will flow through the flow passageways between the stack 230 and support 240 and then through outlet 270. A second gas may be passed through inlet 280, over the outer layer of the stack 230, then out through outlet 290. Sealing mechanism 250 should prevent the mixing of the first and second gas streams. The first gas may comprise a fuel gas stream and the second gas may comprise an oxygen containing gas stream or vice versa.

Other embodiments of the invention comprise methods of preparing or manufacturing fuel cell elements in accordance with the principles of the invention. One embodiment comprises a method for forming a dual chamber fuel cell element, comprising depositing a fuel cell stack onto a sacrificial material supported by a substrate removing the sacrificial material, if necessary, to form one or more flow passageways between the fuel cell stack and substrate.

The fuel cell stack may be deposited by any mechanism or technique as desired or necessitated by a particular end use. Suitable techniques may include, but are not limited to, spin coating, physical vapor deposition, chemical vapor deposition, and the like. The fuel cell stack deposited may have successive layers of anode, electrolyte and cathode materials. In addition, the fuel cell stack may be any thickness desired or necessitated by a particular use. In one embodiment of the invention, the thickness of the fuel cell stack deposited may be equal to or less than about 50 μm. Other embodiments of the invention comprise depositing a fuel cell stack with a thickness of equal to or less than about 20 μm. Still other embodiments of the invention comprise depositing a fuel cell stack with a thickness of equal to or less than about 1 μm.

The particular sacrificial material selected is not critical to the invention and may be any suitable material known or used in the art. For example, some suitable sacrificial materials may include, but are not limited to, metals (e.g., aluminum, aluminum alloys, titanium, titanium alloys, silicon, silicon alloys and the like, including mixtures thereof), di-electric compounds, polymers (e.g., photoresist, PMMA, epoxies, and the like including mixtures thereof), silicon dioxide and the like, including mixtures thereof. The sacrificial material may be removed, if necessary, by any method known or used in the art including, but not limited to, wet or dry etching.

The particular etching material or mechanism selected is not critical to the invention and may be any known or used in the art. Specific etching materials or mechanisms may depend upon the composition of the sacrificial material. Suitable etching materials or mechanisms may include, but are not limited to, TMAH, acetone and oxygen plasma processes, in the case of polymer compounds and acids, bases, fluorine plasmas and chlorine plasmas in the case of metals and oxides. It will be appreciated by one of ordinary skill in the art that the sacrificial material and etching material should be compatible with each other but not with other components of the fuel cell element. In other words, the etching material should selectively remove the sacrificial material but not attack or remove other materials, e.g., current collectors, anode, cathode, electrolyte, and the like.

FIGS. 3a-3c show a dual chamber fuel cell element 300 in various stages of preparation/manufacture in accordance with various embodiments of the invention. In one embodiment of the invention, a current collector 320 is deposited on a substrate 310. A sacrificial material 330 is then deposited and/or patterned on the current collector 320 using any suitable technique, as shown in FIG. 3a. Suitable deposition techniques may include, but are not limited to, spin coating, sputter deposition, physical vapor deposition, chemical vapor deposition, and the like. Suitable patterning techniques may include, but are not limited to, photolithography/etching patterning, screen printing, shadow masking and the like. FIG. 3b shows that a fuel cell stack 340 may then be deposited over the exposed current collector 320 and sacrificial material 330. The sacrificial material 320 may then be exposed by any suitable method or mechanism. For example, the ends of the fuel cell element 300 may be sawn to expose the various layers of the element 300. Alternatively, the various layers may be exposed by laser ablation or etching techniques. Once the sacrificial material 330 is exposed it may be removed. Removal may be carried out by any suitable mechanism. For example, wet or dry etching may be used to remove the sacrificial material 330. Removal of the sacrificial material 330 should result in integrated passageways 360 (FIG. 3c) between the stack 340 and substrate 310. (FIG. 3c also shows that additional current collector material 350 may then be deposited/patterned on at least a portion of the fuel cell stack 340. the placing of current collectors would most likely take place prior to exposing the sacrificial materials).

The above discussion is meant to be illustrative of the principles and various embodiments of the present invention. Numerous variations and modifications will become apparent to those skilled in the art once the above disclosure is fully appreciated. For example, it is within the scope of the invention to use flow passageways created within the support surface as opposed to above the support surface. A stack may be deposited on a substrate having sacrificial material in trenches along the surface. The ends may be exposed and the sacrificial material removed resulting in the trenches becoming flow passageways between the stack and substrate. It is intended that the following claims be interpreted to embrace all such variations and modifications.

1. A dual chamber fuel cell element, comprising:
a dual chamber fuel cell stack layer comprising anode, cathode and electrolyte materials deposited on one side of a substrate.

2. The element of claim 1 wherein one or more separated flow passageways are formed between the stack and the substrate.

3. The element of claim 1 wherein the stack comprises a thickness of equal to or less than 50 μm.

4. The element of claim 1 wherein the stack comprises a thickness of equal to or less than 20 μm.

5. The element of claim 1 wherein the stack comprises a thickness of equal to or less than 1 μm.

6. The element of claim 1 further comprising current collectors.

7. A dual chamber fuel cell element having a supported fuel cell stack comprising integrated flow passageways between the fuel cell stack and the support.

8. The element of claim 7 wherein the stack is comprised of an anode layer, an electrolyte layer and a cathode layer.

9. The element of claim 7 wherein the stack comprises a thickness of equal to or less than 50 μm.

10. The element of claim 7 wherein the stack comprises a thickness of equal to or less than 20 μm.

11. The element of claim 7 wherein the stack comprises a thickness of equal to or less than 1 lm.

12. A dual chamber fuel cell element, comprising:
a fuel cell stack supported on one side of a substrate; and
a means for passing a separated fuel stream and an oxygen containing stream over the fuel cell stack on the same side of the substrate;
wherein the fuel stream and oxygen containing stream remain separated when exposed to the stack.

13. The element of claim 12 wherein the stack comprises a thickness of equal to or less than 50 μm.

14. The element of claim 12 wherein the stack comprises a thickness of equal to or less than 20 μm.

15. The element of claim 12 wherein the stack comprises a thickness of equal to or less than 1 μm.

16. A fuel cell element, comprising:
a fuel cell stack supported on a substrate, the stack comprising successive layers of anode material, electrolyte material and cathode material;
wherein the stack comprises a thickness of equal to or less than 50 μm.

17. The element of claim 16 wherein the stack is deposited on a single side of the substrate.

18. The element of claim 16 further comprising one or more integrated flow passageways between the stack and the substrate.

19. The element of claim 16 wherein the stack comprises a thickness of equal to or less than 20 μm.

20. The element of claim 16 wherein the stack comprises a thickness of equal to or less than 1 μm.

21. A fuel cell, comprising:
one or more fuel cell elements; and
a fuel cell housing;
wherein the fuel cell elements comprise a supported dual chamber fuel cell stack having integrated flow passageways between the fuel cell stack and the support.

22. The fuel cell of claim 21 wherein the stack comprises a thickness of equal to or less than 50 μm.

23. The fuel cell of claim 21 wherein the stack comprises a thickness of equal to or less than 20 μm.

24. The fuel cell of claim 21 wherein the stack comprises a thickness of equal to or less than 1 μm.

25. The fuel cell of claim 21 wherein the fuel cell elements are aligned within the fuel cell housing to allow the flow of a first gas stream within the flow passageways and a second gas stream over the fuel cell stack.

26. The fuel cell of claim 25 wherein the first gas stream comprises a fuel.

27. The fuel cell of claim 25 wherein the second gas stream comprises an oxygen containing gas.

28. The fuel cell of claim 25 wherein the first gas stream comprises an oxygen containing gas.

29. The fuel cell of claim 25 wherein the second gas stream comprises a fuel.

30. A method for forming a dual chamber fuel cell element, comprising:
depositing a fuel cell stack onto a sacrificial material supported by a substrate;
removing the sacrificial layer to form one or more flow passageways between the fuel cell stack and substrate.

31. The method of claim 30 wherein the sacrificial material comprises a material selected from the group consisting of aluminum, aluminum alloys, titanium, titanium alloys, silicon, silicon alloys, di-electric compounds, polymers, photoresist, PMMA, epoxies and silicon dioxide.

32. The method of claim 30 wherein the sacrificial material is removed using a wet etching technique.

33. The method of claim 32 wherein the etching material comprises a material selected from the group consisting of TMAH, acetone, acids and bases.

34. The method of claim 30 wherein the sacrificial material is removed using a dry etching technique.

35. The method of claim 30 wherein the stack is comprised of successive layers of anode, electrolyte and cathode materials.

36. A method for manufacturing a dual chamber fuel cell element, comprising:
(a) depositing a current collector material on a substrate;
(b) patterning a sacrificial material on the current collector material
(c) depositing a fuel cell stack over the exposed current collector material and sacrificial material;
(d) patterning additional current collector material on at least a portion of the fuel cell stack;
(e) exposing the sacrificial material; and
(f) removing the sacrificial material.

37. A method preparing a fuel cell element, comprising:
depositing anode material, electrolyte material and cathode material on a support to form a fuel cell stack; and
a step for creating flow passageways between the stack and support.

38. The method of claim 37 wherein the flow passageways are above the surface of the support.

39. The method of claim 37 wherein the flow passageways are along the surface of the support.
